(19) United States
(12) Patent Application Publication
(10) Pub. No.: US 2016/0084412 A1
(43) Pub. Date: Mar. 24, 2016

(54) COUPLING BARREL AND METHODS OF PRODUCING THEREOF

(71) Applicants: Jonathan Carl Reinheimer, Surrey (CA); David C. Brewer, Mission (CA)

(72) Inventors: Jonathan Carl Reinheimer, Surrey (CA); David C. Brewer, Mission (CA)

(21) Appl. No.: 14/494,562

(22) Filed: Sep. 23, 2014

(51) Int. Cl. F16L 21/04; B21D 39/02; B21B 1/22; B21D 31/04; F16L 21/00; F16L 21/02

(52) U.S. Cl. CPC F16L 21/04; F16L 21/002; F16L 21/022; B21B 1/22; B21D 31/04; B21D 39/028

(57) ABSTRACT

A coupling barrel having cavities and roll-formed from a single unit of material is described. The coupling barrel includes a wall, lips angularly extending from the wall that define the cavities, and wings angularly extending from the lips. A coupling assembly include the coupling barrel, a pair of glands, and a pair of seals is also described.

### FIELD

The disclosure relates generally to coupling barrels and, more particularly, to fabricated single body coupling barrels.

### BACKGROUND

Numerous types of coupling barrels with various types of sealing cavities exist in the market, with two types of sealing cavities being the AWWA C219 and the AWWA C111. The AWWA C219 cavity is typically produced from a single unit of material and is cast with a beveled sealing surface allowance at each end or is fabricated with flared ends into couplings of various sizes. Further, a traditional coupling barrel with an AWWA C219 cavity does not have wings for containing a seal in a coupling assembly to produce an air and/or water tight seal as the C111 cavity does.

### SUMMARY

An aspect of this disclosure relates to a fabricated coupling barrel roll-formed to produce cast cavity (e.g., an AWWA C111 cast cavity) using a single unit of material. The coupling barrel includes lips and wings extending from a wall of the coupling barrel.

Another aspect of this disclosure relates to a fabricated coupling assembly that simulates cast cavities and utilizes a gland or cast, either cast or fabricated, that conforms to specifications as well. In an embodiment, the gland retains a seal in a cavity located between the outer diameter of a pipe and the lips and wings of the coupling barrel. In a further embodiment, the gland includes at least one spigot that retains the seal in the cavity. Use of the seal results in an air and/or water tight seal between the coupling barrel and the outer diameter of a pipe. The coupling barrel disclosed herein provides a cost effective and more reliable alternative to typical cavity casted coupling barrels.

A further aspect of this disclosure relates to a method of producing a coupling barrel roll-formed to produce cast cavities and wings using a single unit of material.

Additional features and advantages of this disclosure are described below. This disclosure may be readily utilized as a basis for modifying or designing other structures, systems, and processes for carrying out the same purposes of this disclosure. It should also be realized by those skilled in the art that such equivalent implementations do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of this disclosure.

### BRIEF DESCRIPTION OF THE DRAWINGS

The particular features and advantages of this disclosure will be apparent from the detailed description set forth below in conjunction with the drawings in which like reference characters identify corresponding aspects throughout.

FIG. 1 is a prospective view of a coupling barrel according to this disclosure.

FIG. 2 is a planar view of a coupling barrel according to this disclosure.

FIG. 3 is a prospective view of a coupling assembly according to this disclosure.

FIG. 4 is an expanded side view of a coupling assembly according to this disclosure.

FIG. 5 is a side view of a gland according to this disclosure.

FIG. 6 is a flow diagram describing a method of producing a coupling barrel according to this disclosure.

### DETAILED DESCRIPTION

The detailed description set forth herein makes reference to the accompanying drawings, which show various aspects of this disclosure by way of illustration. While these various aspects are described in sufficient detail to enable those skilled in the art to practice the disclosure, it should be understood that other embodiments and implementations may be realized and that logical and mechanical changes may be made without departing from the scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment, for example.

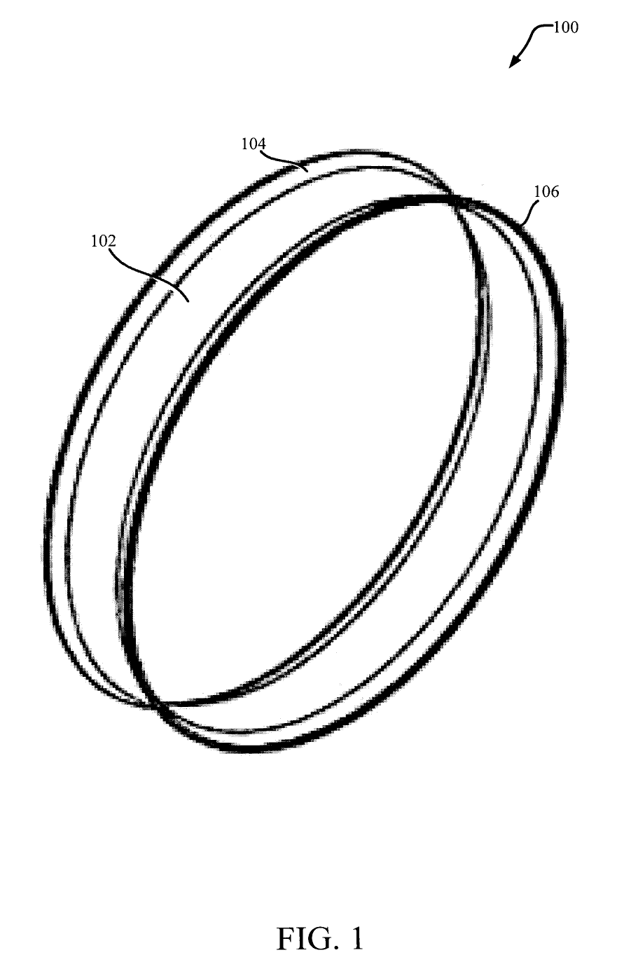

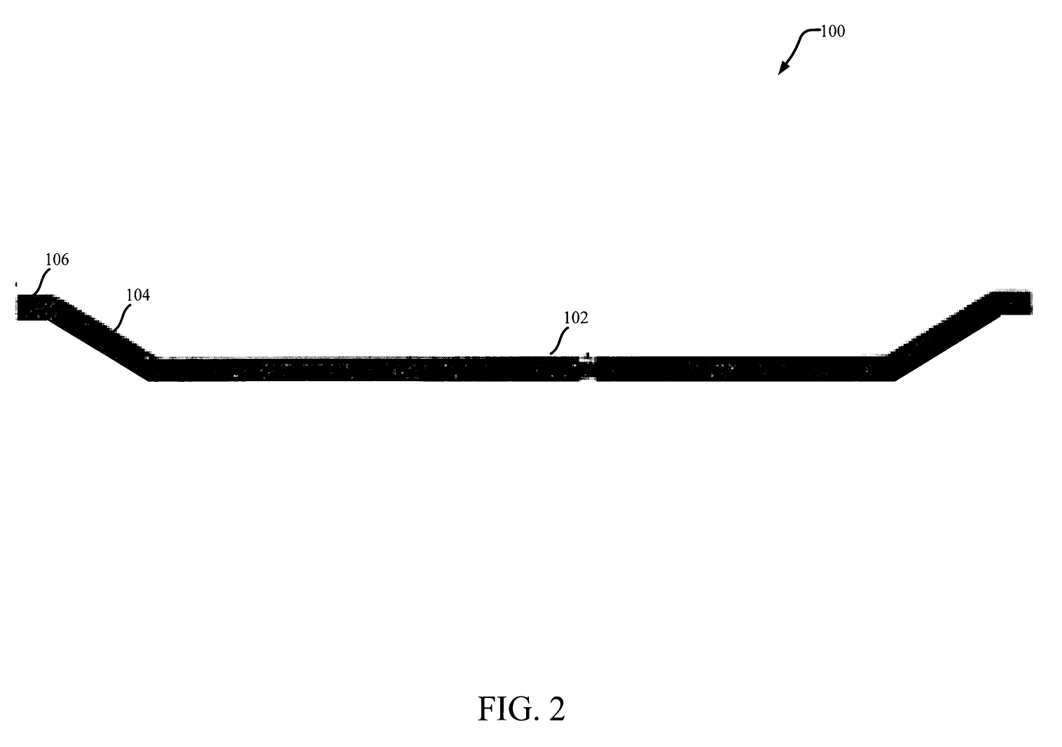

According to an aspect of this disclosure, a coupling barrel 100 is described with reference to FIGS. 1 and 2. The coupling barrel 100 may be roll-formed using a single unit of material, resulting in the formation of a wall 102, lips 104, and wings 106.

In various embodiments, the single unit of material used to produce the coupling barrel 100 may include metal, metal alloy, plastic, or any other material suitable to perform the characteristics of the coupling barrel 100 disclosed herein. The single unit of material may further be measured and cut to a shape that, when roll-formed, produces a coupling barrel 100 as described herein. Further, in another embodiment, the single unit of material may be roll-formed prior to being cut into the shape of a coupling barrel 100 as described herein. The single unit of material may be flat or substantially flat prior to being roll-formed into the coupling barrel 100.

The coupling barrel 100 may have any shape capable of being produced by roll-forming techniques. Such shape of the coupling barrel 100 may be dictated by the shape of the pipes to be coupled to the coupling barrel 100. In an embodiment, the coupling barrel 100 may have a circular or substantially circular shape.

The wall 102 may be configured to define a small cavity measured from a first point on the wall 102 to a second point on the wall 102 distal from the first point. In an illustrative embodiment, a length, or in some embodiments a diameter, of the small cavity may equal a length, or in some embodiments, a diameter of the wall 102 measured from first and second points located on an interior surface of the wall 102. In another embodiment, the length or diameter of the small cavity may equal a length or diameter of the wall 102 measured from first and second points located on an exterior surface of the wall 102. In yet another embodiment, the length or diameter of the small cavity may equal a length or diameter of the wall 102 measured from a first point on the interior surface of the wall 102 to a second point located on the exterior surface of the wall 102. According to an embodiment, the small cavity may have a length or diameter equal or substantially equal to 24 inches. In yet another embodiment, the small cavity may have a length or diameter greater than about 24 inches, but less than about 48 inches.

A lip 104 may angularly extend from each edge of the wall 102, thereby defining cavities (e.g, AWWA C111 cavities). According to multiple embodiments, the lips 104 may be uniform in size and/or shape. However, the lips 104 may be unequal in size and/or shape without departing from the scope of this disclosure. According to various embodiments, the lips 104 may extend from edges of the wall 102 at equal angles. However, the lips 104 may also extend at unequal angles without departing from the scope of this disclosure. According to an embodiment, such angular extension of a lip 104 may be measured between a plane of the wall 102, extending along the interior surface of the wall 102 between both edges of the wall 102, and a side of the lip 104. In an illustrative embodiment, one or both of the lips 104 may extend from the wall 102 at an angle in the range of about 20 degrees to about 30 degrees. According to multiple embodiments, one or both of the lips 104 may extend from the wall 102 at an angle equal to or substantially equal to 20 degrees, 25 degrees, or 30 degrees.

According to other embodiments, each lip 104 may be configured to define an AWWA C111 cavity measured from a first point on a lip 104 to second point on the same lip 104 distal from the first point. In an illustrative embodiment, a length, or in some embodiments a diameter, of the AWWA C111 cavity may equal a length, or in some embodiments, a diameter of a lip 104 measured from first and second points located on an interior surface of the lip 104. In another embodiment, the length or diameter of the AWWA C111 cavity may equal a length or diameter of a lip 104 measured from first and second points located on an exterior surface of the lip 104. In yet another embodiment, the length or diameter of the AWWA C111 cavity may equal a length or diameter of a lip 104 measured from a first point on the interior surface of the lip 104 to a second point located on the exterior surface of the lip 104. According to multiple embodiments, the AWWA C111 cavity may have a length or diameter equal or substantially equal to 14 inches, 16 inches, 18 inches, 20 inches, 24 inches, 30 inches, 36 inches, 42 inches, or 48 inches.

Wings 106 may angularly extend from edges of the lips 104. According to multiple embodiments, the wings 106 may be uniform in size and/or shape. However, the wings 106 may be unequal in size and/or shape without departing from the scope of this disclosure. According to various embodiments, the wings 106 may extend from edges of the lips 104 at equal angles. However, the wings 106 may also extend at unequal angles without departing from the scope of this disclosure. The wings 106 may extend from the lips 104 at an angle that results in the wings 106 being in horizontal alignment with a plane of the wall 102 that extends along either the interior or exterior surface of the wall 102 between the two edges of the wall 102.

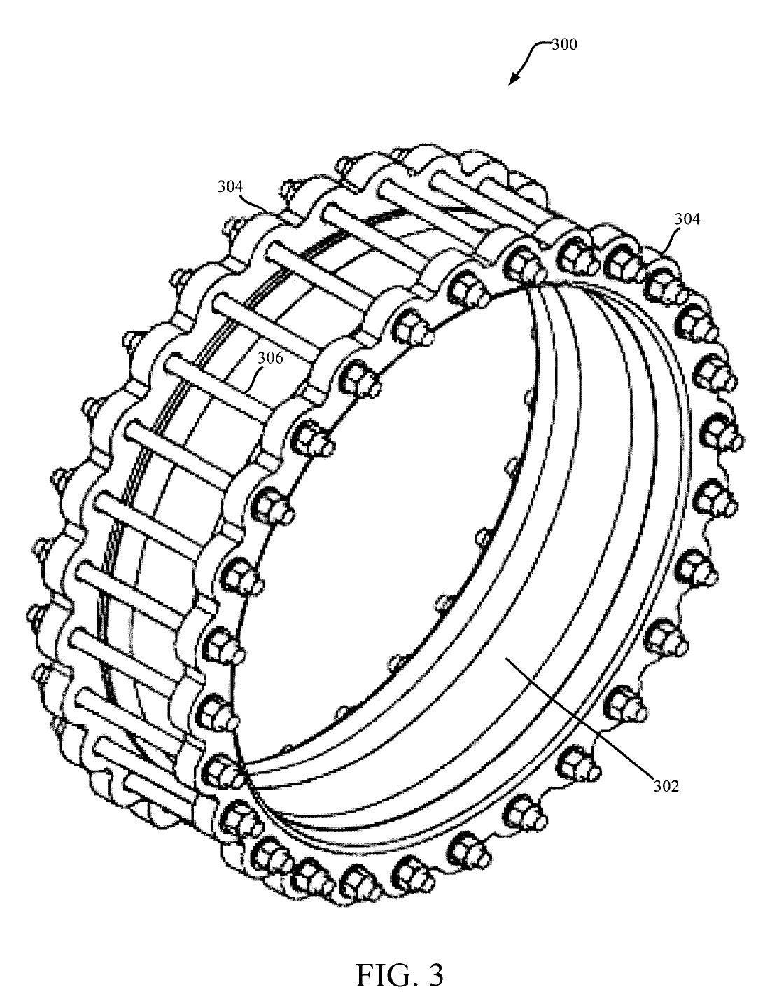

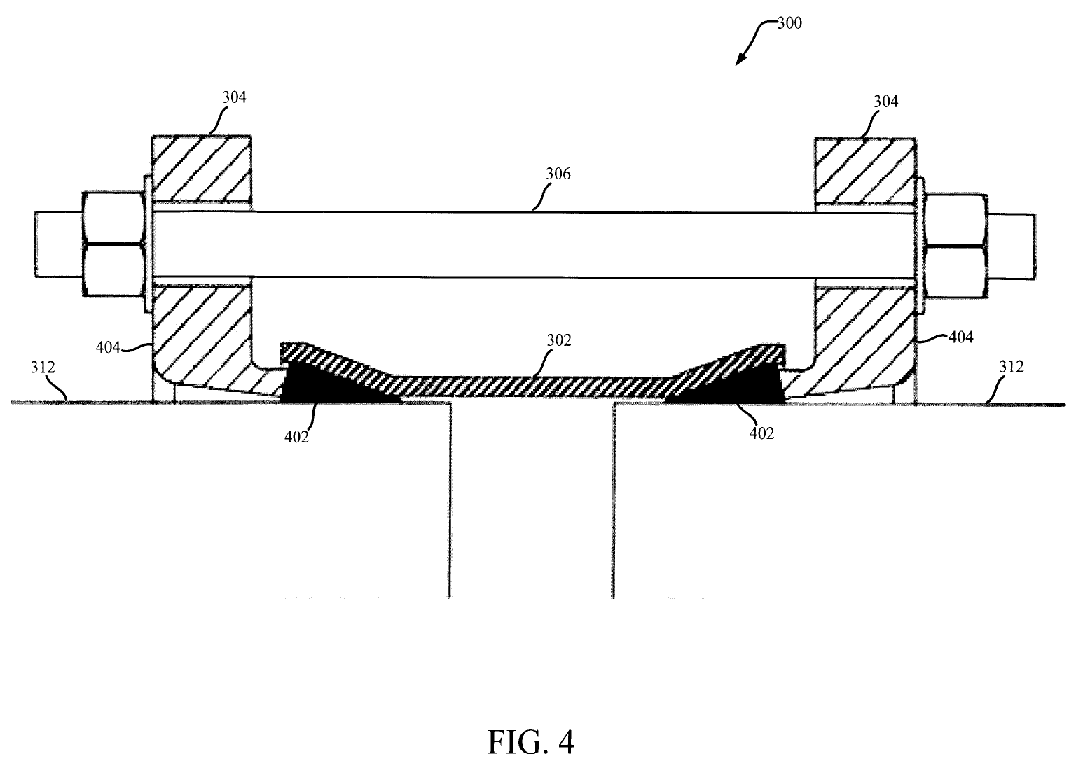

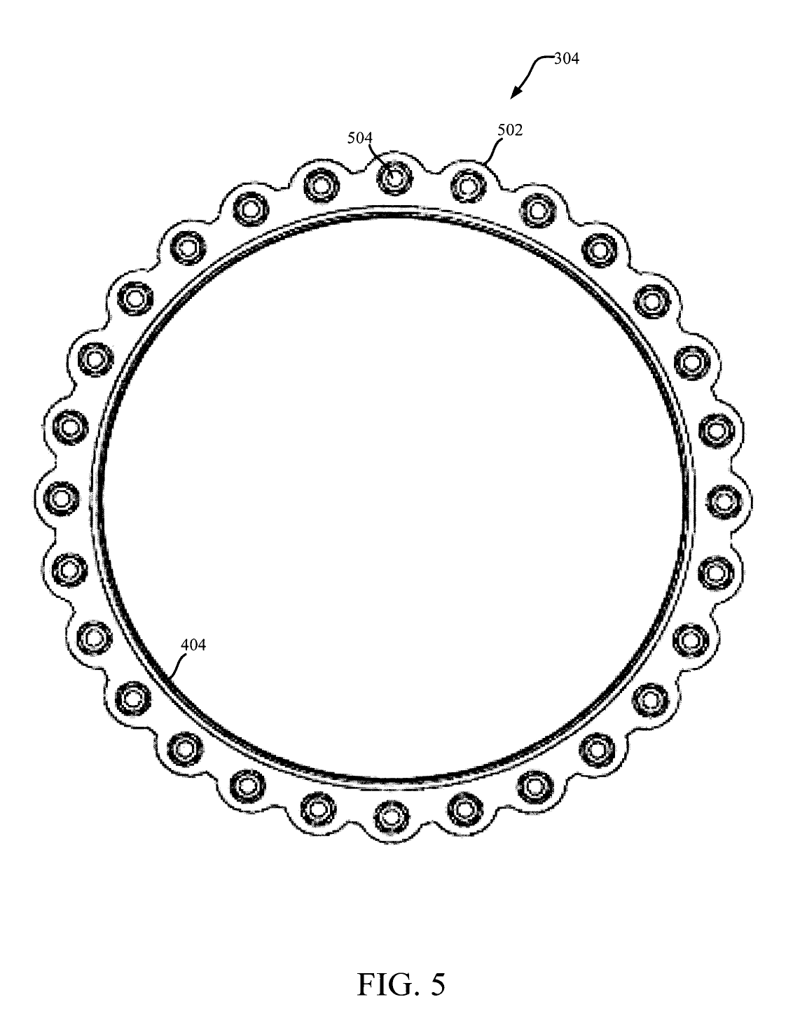

According to another aspect of this disclosure, a coupling assembly 300 is described with reference to FIGS. 3-5. The coupling assembly 300 may include a coupling barrel 302, a pair of glands 304, fasteners 306, and a pair of gaskets 402.

The coupling barrel 302 may have any shape sufficient to fit around a pipe 312. According to an embodiment, the coupling barrel 302 has a circular shape. The coupling barrel 302 may further have all the components and attributes of the coupling barrel 100 described with reference to FIGS. 1 and 2 above. Thus, the coupling barrel 302 may include, for example, a wall, lips that define AWWA C111 cavities, and wings all roll-formed from a single unit of material.

The pair of glands or casts 304 may be located proximate or abut edges of the coupling barrel 302. According to an embodiment, the pair of glands 304 may be located proximate or abut wings of the coupling barrel 302. The pair of glands 304 may be formed to have any shape and each gland 304 may have a spigot 404 having any shape capable of surrounding a pipe 312 when the pipe 312 is inserted through the gland 304. Each gland 304 may also have partially protruding regions 502 that extend outwardly away from the spigot 404. The partially protruding regions 502 may be formed to have any shape and may have holes 504 located therethrough. The holes 504 may be shaped to allow fasteners 306 therethrough. The fasteners 306 may be any fastener capable of drawing each of the glands 304 closer together. Such fasteners 306 may include mechanical fasteners, such as bolts, threaded bars with nuts, and screws, for example.

According to another embodiment, one gland 304 may have unthreaded holes 504 located through its partially protruding regions 502 and the other gland 304 may have threaded holes 504 located entirely or partially through its partially protruding regions 502. Fasteners 306, for example, bolts or screws, may be used to pull or draw the glands 304 toward each other.

Each gasket 402 of the pair of gaskets 402 may be located in a simulated cavity defined by the coupling barrel 302, a spigot 404 of a gland 304, and the outer edge of a pipe 312. In an embodiment, the simulated cavity may be defined by sides of a lip (which defines the AWWA C111 cavity) and a wing of the coupling barrel 302, a spigot 404 of a gland 304, and the outer edge of a pipe 312. The gaskets 402 may be of any shape and/or size sufficient to provide an air and/or water tight seal between the elements that define the simulated cavity in which each gasket 402 is located. According to an embodiment, each gasket 402 may have a surface equal in shape and/or size to the outer edge of the pipe 312, another surface equal in shape and/or size to the spigot 404 of the gland 304, and a further surface equal in shape and/or size to the surface of the coupling barrel 302 that it contacts. In another embodiment, the surface of the coupling barrel 310 may include sides of a lip (which defines the AWWA C111 cavity) and a wing.

According to an aspect of this disclosure, an air and/or water tight seal is produced when the fasteners 306 are manipulated to provoke the glands 304, and simultaneously the spigots 404, closer to each other. Thereby, each gland 304 becomes closer to the coupling barrel 302, and in some embodiments a lip and a wing of the coupling barrel 302. The gaskets 402 may thereby shift and/or maneuver within the simulated cavity until surfaces of the gaskets 402 sufficiently contact the surfaces that define the simulated cavity to produce the air and/or water tight seal.

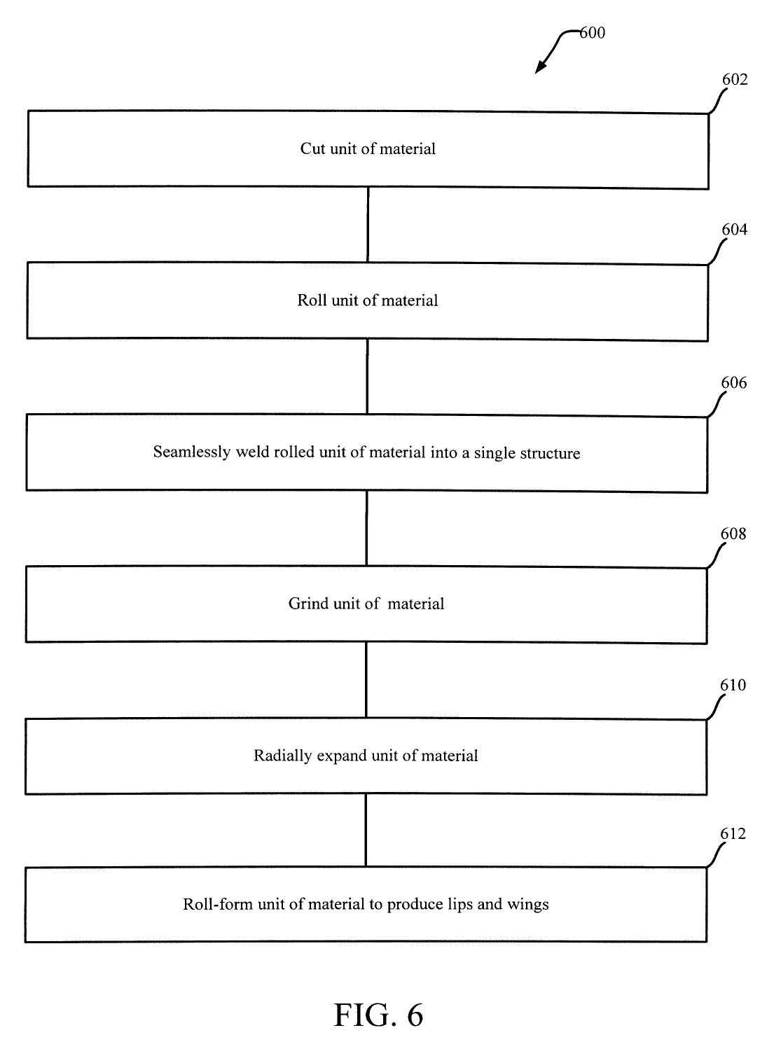

A method 600 of producing a coupling barrel of this disclosure is described with reference to FIG. 6. At block 602 a single unit of material is cut to a desired shape. In an embodiment, the unit of material is a flat or substantially flat bar. According to multiple embodiments, the single unit of material may be ¼ inches or ⅜ inches thick and 7 inches, 10 inches, 12 inches, or 16 inches wide. At block 604 the single unit of material is rolled into a desired shape. In an embodiment, the shape is a circle or substantially a circle. At block 606 the rolled single unit of material is seamlessly welded into a single structure. In an embodiment, the single structure is a circle. At block 608 the single unit of material is ground clean and flushed to produce a smooth or substantially smooth finish. At block 610 the single unit of material is radially expanded to produce a small cavity of a desired size. In an embodiment, the radial expansion of the single unit of material involves cold working the single unit of material into a perfect or substantially perfect circle. At block 612 lips (that define AWWA C111 cavities) and wings are roll-formed into the single unit of material.

This disclosure is in no way restricted to the specific disclosure of the specification and drawings, but also encompasses any modifications within the scope of the appended claims.

What is claimed is:

1. A roll-formed coupling barrel with cavities comprising:
a wall;
lips angularly extending from the wall, the lips defining the cavities; and
wings angularly extending from the lips.

2. The coupling barrel of claim 1, wherein the wall defines a C111 cavity having a diameter greater than 12 inches.

3. The coupling barrel of claim 2, wherein the lips have equal lengths.

4. The coupling barrel of claim 2, wherein the lips have unequal lengths.

5. The coupling barrel of claim 2, wherein the lips extend from the wall at equal angles.

6. The coupling barrel of claim 2, wherein the lips extend from the wall at unequal angles.

7. The coupling barrel of claim 1, wherein at least one of the lips extend from the wall at an angle selected from the group consisting of about 20 degrees, about 25 degrees, or about 30 degrees.

8. The coupling barrel of claim 1, wherein the wings have equal lengths.

9. The coupling barrel of claim 1, wherein the wings have unequal lengths.

10. The coupling barrel of claim 1, wherein the wings extend from the lips at equal angles.

11. The coupling barrel of claim 1, wherein the wings extend from the lips at unequal angles.

12. The coupling barrel of claim 1, wherein the wings are in horizontal alignment with a plane of the wall.

13. The coupling barrel of claim 2, wherein each of the lips define C111 cavities having diameters equal to at least one of about 14 inches, about 16 inches, about 18 inches, about 20 inches, about 24 inches, about 30 inches, about 36 inches, about 42 inches, or about 48 inches.

14. A coupling assembly comprising:
a coupling barrel having a wall, lips defining cavities, and wings, the coupling barrel being produced by roll-forming a single unit of material;
a pair of glands removably contactable with the wings, each of the pair of glands including a spigot, the pair of glands being connected by fasteners; and
a pair of gaskets located in simulated cavities, each of the simulated cavities defined by a lip, a wing, a spigot, and an outer diameter of a pipe, each of the simulated cavities housing one of the pair of gaskets, each of the pair of gaskets being configured to seal the simulated cavity upon the pair of glands being drawn together by the fasteners.

15. The coupling assembly of claim 14, wherein each of the pair of glands has partially protruding regions that extend outwardly away from the spigot.

16. The coupling assembly of claim 14, wherein the lips angularly extend from the wall at an angle of about 30 degrees.

17. A method of making a coupling barrel with defined cavities produced from a single unit of material comprising:
rolling the single unit of material;
welding the rolled single unit of material into a single structure;
radially expanding the single unit of material; and
roll-forming the single unit of material to produce lips and wings, the lips defining the cavities.

18. The method of claim 17, further comprising:
grinding the single unit of material.

19. The method of claim 17, wherein the roll-forming step includes producing lips that angularly extend at an angle of about 30 degrees.

20. The method of claim 17, wherein the radially expanding step includes cold working the single unit of material.
